(19) United States
(12) Patent Application Publication
(10) Pub. No.: US 2010/0262996 A1
(43) Pub. Date: Oct. 14, 2010

(54) DISPLAY SYSTEM AND DISPLAY METHOD OF TV PROGRAM APPENDED INFORMATION

(75) Inventor: Chiao-Yung Chang, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 12/541,036

(22) Filed: Aug. 13, 2009

(30) Foreign Application Priority Data
Apr. 13, 2009 (TW) 098112191

(51) Int. Cl. H04N 5/445; H04N 7/173; G06F 13/00

(52) U.S. Cl. 725/43; 725/110; 725/53

(57) ABSTRACT

A TV program appended information display system includes a display screen and a host. The host communicates with the display screen for executing an application program to receive a TV signal, showing a TV program corresponding to the TV signal on a first image frame of the display screen, and acquiring channel information associated with contents of the TV program. The host communicates with an internet to acquire TV program appended information through the internet according to the channel information, so that the TV program appended information is shown on the display screen by the host.

### FIELD OF THE INVENTION

The present invention relates to a TV program appended information display system, and more particularly to a TV program appended information display system for performing an internet searching operation according to the channel information associated with the contents of the TV program, thereby showing the TV program appended information. The present invention also relates to a TV program appended information display method.

### BACKGROUND OF THE INVENTION

Nowadays, many electrical appliances are widely used with computers due to the amazing power of computers. For example, the TV programs shown on a cable TV or a wireless television can be transmitted to the personal computer for playback. Typically, the TV signals issued from the TV set can be transmitted to the personal computer by externally wiring a TV box to the computer or inserting a TV tuner card into the computer. In such way, the TV programs can be displayed on the personal computer in a wired or wireless transmission manner, and thus the personal computer has an extended function of serving as a TV set.

FIG. 1A is a schematic circuit block diagram illustrating a computer system for processing TV signals to TV programs. As shown in FIG. 1A, the computer system 100 comprises a host 10, a TV tuner card 14, a mouse 12 and a display screen 11. The TV tuner card 14 could receive TV signals. After channel selections, encoding/decoding operations and signal format conversions are implemented in the TV tuner card 14, the processed signals are transmitted to the host 10 via a bus 16. As a consequence, the TV programs could be displayed on an image frame 18 of the display screen 11.

In a case that the computer system is a desktop computer system, the TV tuner card conforms to the specification of a peripheral component interconnect (PCI) interface. With increasing development of mobile computing technology industries, a variety of portable electronic devices such as notebook computers, personal digital assistants (PDAs), small-sized liquid crystal display devices, mobile televisions or mobile phones become essential electronic products because they are feasible to be used in many instances. On account of their portability, notebook computers are gradually used to view TV programs. The built-in or external TV tuner cards applied to notebook computers include Cardbus interface cards, high-speed transmission interface cards (ExpressCard), USB extension cards, or the like. By using an antenna unit of the built-in or external TV tuner card to receive wireless TV signals (e.g. radio frequency signals), wireless TV programs could be shown on the notebook computer. In addition, when the TV tuner card is connected with a TV signal input terminal of a cable TV, the cable TV programs could be shown on the notebook computer.

For using the hardware components of the TV tuner card to reproduce the TV programs in real time, an application program associated with the TV tuner card is executed in the host, and thus an image frame including the contents of the TV program is shown on the display screen or a monitor of the host. FIG. 1B is a schematic diagram illustrating an image frame and a user operation interface shown on the display screen in response to execution of an application program. Generally, the image frame 18 is shown on the display screen 11 in a PIP (picture-in-picture) mode. In other words, after the host 10 is booted, the operating system will create a desktop environment on the display screen 11. The image frame 18 could be superposed on the desktop environment and the size of the image frame 18 could be adjusted as required. Moreover, when application program is executed, a user operation interface 180 is shown on the display screen 11 and arranged beside the image frame 18. By manipulating a control device (e.g. the mouse 12 shown in FIG. 1A), the function items of the user operation interface 180 could be selected and controlled in order to control playback or other operations of the TV signals.

Generally, the contents of the TV program are shown on the display screen 11 and refreshed in real time. When the TV channel is switched to a new one, the contents of the TV program are correspondingly changed. On the other hand, during playback of the analog TV signals, only the audio/video contents of the TV program are shown. As the transmitting quality of the digital TV signal is gradually enhanced, the digital TV signal could be compressed and encoded and thus more information could be loaded into the TV channel. The information is for example channel information, including the channel frequency, the identification code, the electronic programming guide (EPG), the channel number, the program name, the program category and/or the like. Via the electronic programming guide, the user could realize the name or category of the current TV program from a specified display zone while watching the current TV program. Alternatively, the user could realize the next TV program of this TV channel via the electronic programming guide.

Although the channel information could facilitate the user to realize the contents of the TV program, the channel information is still insufficient to understand the contents of the TV program. For further realizing the remarks about the contents of the TV program or extended-reading the contents of the TV program, the user usually links to the search engine and performs an internet searching operation.

Recently, many video sharing websites are used for sharing and searching certain categories of TV programs or certain categories of video data. For example, YouTube is a common video sharing website on which users can upload and share video files. Such a video sharing website is connected with a network server for receiving the video files or video data from client terminals. When the users communicate with the network server through the internet connection, the users could select desired video files or video data and thus the video files or video data are shown on the display screens of their computer systems. For achieving the extended-reading purpose while viewing a video file or video data, some important information associated with the current video file or video data is also shown on the display screen. For example, the important information includes the video data belonging to the same category, the previous and next episodes of the current video file or data, other uploaded data of the same author, text remarks from other viewers or linking recommendation of other files. The provision of the important information results in convenience and amusement. As known, the extended-reading efficacy of the video sharing website is restricted to some circumstances in which the video files or data are uploaded to and stored in the database of the network server. In addition, the contents of TV programs on different channels of various TV stations fail to be shown on the video sharing website in real time.

Moreover, the user operation interface beside the image frame could facilitate the user to control playback or other operations of the TV signals. It is critical to exhibit more useful information in limited display area on account of designing the TV tuner card or related application program. Therefore, there is a need of providing a TV program appended information display system for acquiring TV program appended information and achieving an extended-reading purpose while the computer system is used to view real-time TV programs.

### SUMMARY OF THE INVENTION

An object of the present invention provides a TV program appended information display system and a TV program appended information display method. When a TV program is shown on a display screen, an internet searching operation is automatically performed to acquire TV program appended information, thereby achieving an extended-reading purpose.

In accordance with an aspect of the present invention, there is provided a TV program appended information display system for use in an internet. The TV program appended information display system includes a display screen and a host. The host communicates with the display screen for executing an application program to receive a TV signal, showing a TV program corresponding to the TV signal on a first image frame of the display screen, and acquiring channel information associated with contents of the TV program. The host communicates with the internet to acquire TV program appended information through the internet according to the channel information, so that the TV program appended information is shown on the display screen by the host.

In accordance with another aspect of the present invention, there is provided a TV program appended information display method for use with a computer system including a host and a display screen. The host communicates with an internet. The TV program appended information display method includes the following steps. Firstly, an application program is executed in the host to receive a TV signal, and a TV program corresponding to the TV signal is shown on a first image frame of the display screen. Then, channel information associated with the contents of the TV program is acquired by the host. According to the channel information, TV program appended information is acquired through the internet. Afterwards, the TV program appended information is shown on the display screen by the host.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic circuit block diagram illustrating a computer system for processing TV signals to viewable TV programs;

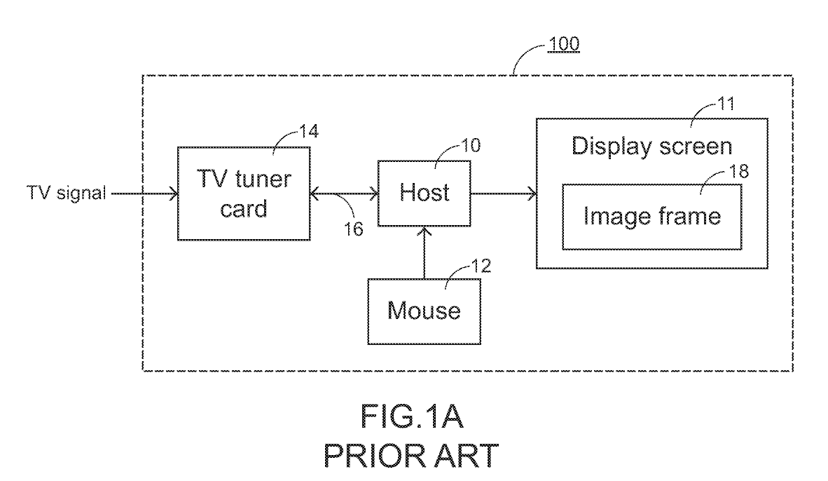

FIG. 1B is a schematic diagram illustrating an image frame and a user operation interface shown on the display screen in response to execution of an application program;

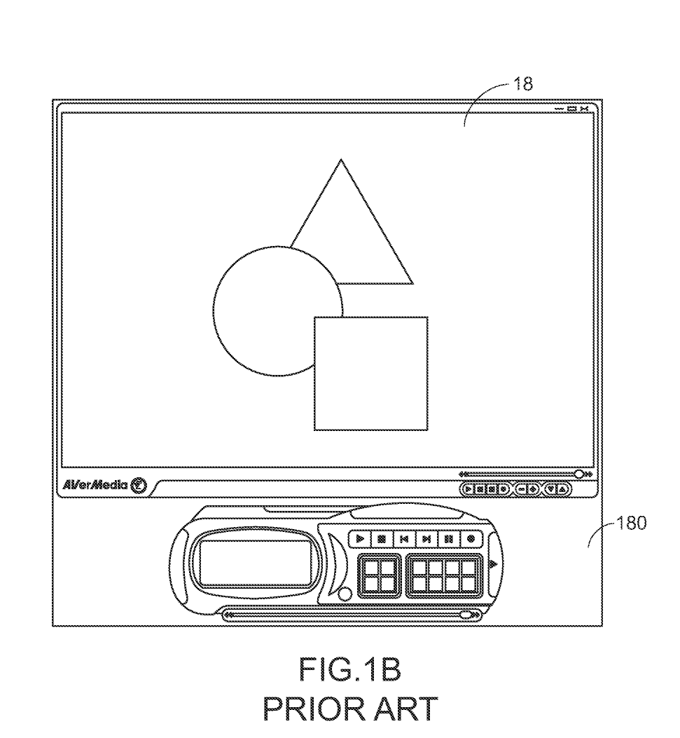

FIG. 2 is a schematic functional block diagram illustrating a TV program appended information display system according to an embodiment of the present invention;

FIG. 3 is schematic diagram illustrating a first image frame and an information frame shown on the display screen; and

FIG. 4 is a flowchart illustrating a TV program appended information display system of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

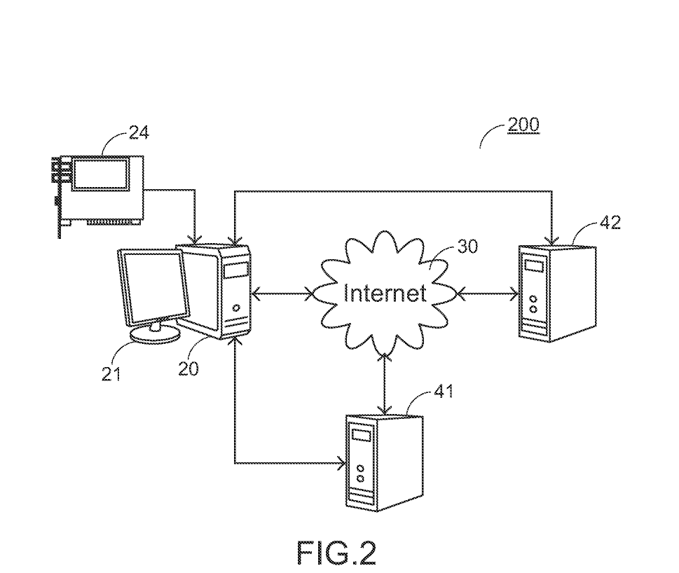

FIG. 2 is a schematic functional block diagram illustrating a TV program appended information display system according to an embodiment of the present invention. The TV program appended information display system 200 is illustrated by referring to a computer system having a function of viewing TV programs. The computer system is for example a desktop computer system or a notebook computer system. The computer system has an external TV box or a built-in TV tuner card for receiving wired or wireless TV signals in an analog or digital format. According to the software or firmware design, the function of showing TV program appended information is executed by an application program included in the TV tuner card or associated hardware components. By executing the application program, the TV program appended information is shown on the display screen of the computer system while the user views the TV program.

As shown in FIG. 2, the TV program appended information display system 200 comprises a host 20 and a display screen 21. The host 20 and the display screen 21 communicate with each other. A TV tuner card 24 is mounted within the host 20. The TV tuner card 24 could receive wired or wireless signals when the TV tuner card 24 is in communication with a cable signal terminal or a wireless signal terminal. After the host 20 is booted, an application program included in the TV tuner card 24 will be downloaded into the operating system of the host 20. During operations of the operating system, the user may manipulate a control device (e.g. a mouse) to execute the application program. As such, the TV programs corresponding to the TV signals received by the TV tuner card 24 could be shown on the display screen 21.

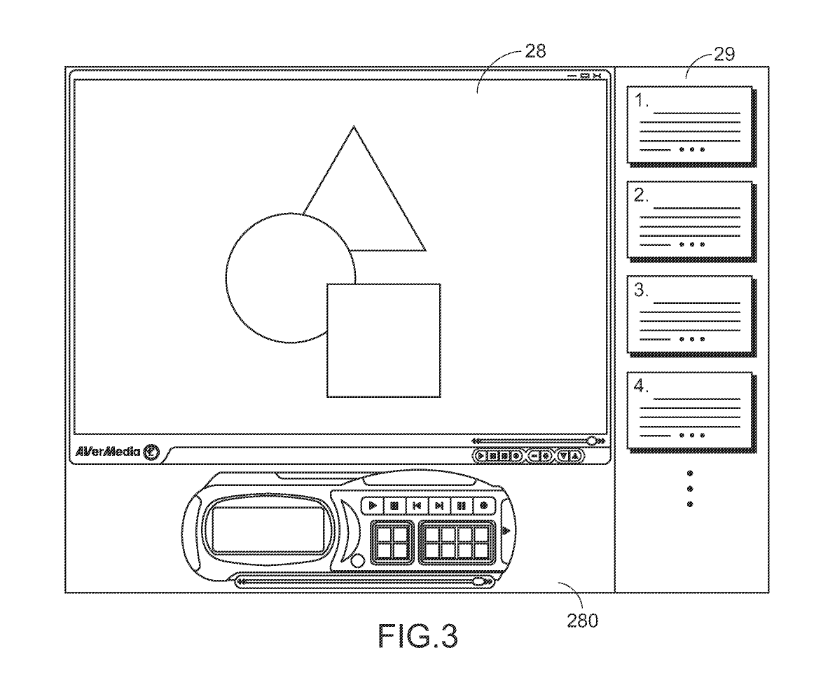

FIG. 3 is schematic diagram illustrating a first image frame and an information frame shown on the display screen. Please refer to FIGS. 2 and 3. When a TV signal is received by the host 20, the streaming data of TV signal are continuously received and refreshed in real time. The TV signal is processed by the host 20, and then the TV program corresponding to the TV signal is shown on the first image frame 28. During the TV signal is received, the channel information associated with the contents of the TV program is also acquired. The channel information includes an electronic programming guide (EPG). Alternatively, the channel information includes a program name, a program category or a channel number of the TV program. In a case that the TV signal is a digital signal, the channel information is directly included in the TV signal and simultaneously received by the host 20. Whereas, in another case that the TV signals are analog signals, the channel information is acquired by the host 20 by using another approach, which will be described later.

Take a digital TV signal for example. Since the channel information is directly included in the TV signal, the host 20 could realize the name and category of the current TV program, the same as the information included in the electronic programming guide (EPG). The information can be obtained from the electronic programming guide according to a channel selection of the TV tuner card 24 and the corresponding time. In some embodiments, the channel information includes a keyword. After the keyword is inputted into a search box of a search engine, desired TV program appended information will be obtained. As shown in FIG. 2, the TV program appended information display system 200 further comprises a first server 41. The first server 41 communicates with the host 20 and an internet 30. Via the first server 41, an internet searching function associated with the channel information is performed in order to obtain the desired TV program appended information.

As previously described, the channel information is directly included in the TV signal if the TV signal is a digital signal. When the TV signal is received by the host 20 and the contents of the corresponding TV program is shown on display screen 21, the host 20 issues a first information searching signal to the first server 41 according to the channel information. In some embodiments, the channel information includes the description texts about the program name and the program category (e.g. a feature film, an athletic contest film, a news film or the like) of the current TV program. The description texts are also used as keywords. When the first information searching signal is received by the first server 41, a keyword (i.e. the channel information) is inputted into a search box of a search engine. An internet searching function associated with the keyword is performed in order to obtain the relative data or files, which are then sorted and processed.

For example, Google and Yahoo are common search engines for internet searching. The process of inputting a keyword into the search box of the search engine to perform the internet searching operation is known in the art, and is not redundantly described herein. In accordance with the present invention, the internet searching operations are automatically done on specified or more search engines by using the description texts which are deemed as keywords. Since the display zone is limited and too many searching results are obtained, the searching results should be sorted and processed. For example, the searching results should be sorted in the order decided by the programmer of the first server 41.

Alternatively, the searching results should be sorted in the order according to the original design of the search engine. Generally, according to the original design of the search engine, the searching results are sorted in the order of the click-through rate by the viewers. For example, the programmer of the first server 41 could define the searching results having the highest click-through rate as the TV program appended information. Alternatively, the searching conditions could be defined by the application program executed in the host 20 or another application program executed in the first server 41. For example, if the TV program appended information in a specified format (e.g. a video format, a sound format, a picture format or a text format) could be processed by the host 20, the searching results to be sorted should only contain the TV program appended information in such a specified format. In such manner, the TV program appended information will be transmitted from the first server 41 to the host 20.

Please refer to FIG. 3 again. After the contents of the TV program corresponding to TV signal is shown on the first image frame 28 by the host 20, the TV program appended information is shown on the display screen 21 by the host 20. Moreover, a user operation interface 280 is shown on the display screen 21 and arranged beside the first image frame 28. Similar to the user operation interface 280, an information frame 29 is also shown beside the first image frame 28 or the user operation interface 280 in order to exhibit the TV program appended information. In some embodiments, according to the size of the first image frame 28, the information frame 29 and the first image frame 28 could be shown on the display screen 21 in a PIP (picture-in-picture) mode. Since the display area of the information frame 29 is limited, only some searching results corresponding to the TV program appended information are shown on the information frame 29. In some embodiments, the information frame 29 further includes a scroll bar (not shown). By moving the scroll bar, more searching results could be realized.

As shown in FIG. 3, the information frame 29 includes several displaying zones for showing the TV program appended information. These displaying zones have respective serial numbers. Each displaying zone includes texts or graphs, which are associated with the keynote, the beginning part of the contents or a related picture or photograph of the searching result. In particular, the TV program appended information includes a text remark about the TV program, a rating of the TV program, related advertisement or recommended information. According to the TV program appended information shown on the information frame 29 of the display screen 21, the user could select the searching results of interest.

By moving the mouse to click a desired displaying zone, the detailed and complete contents of the TV program appended information will be shown in a hyperlink manner. That is, by clicking the displaying zone, a destination website corresponding to the TV program appended information is linked. Via the destination website, the user could acquire a text remark about the TV program, a rating of the TV program, related advertisement or recommended information, so that the extended-reading purpose is achieved. In some embodiments, after the displaying zone is clicked, a second image frame (not shown) is shown on the display screen 21 in a hyperlink manner. The whole contents of the TV program appended information are shown on the second image frame.

In some embodiments, the second image frame overlaps other frame, for example the first image frame 28, the information frame 29, or the user operation interface 280 as in a PIP (picture-in-picture) mode. In addition, by manipulating the mouse, the user can select the desired frame in the PIP mode. In some embodiments, the TV program appended information is exhibited in diverse format such as a video format, a sound format, a graph format or a text format. That is, the second image frame is shown and operated according to the format of the TV program appended information and the software supported by the operating system of the host 20 (e.g. WORD software, multimedia playback software, PDF software, picture software and IE browser software).

As previously described in the prior art, for obtaining related information of the current TV program, a web browser should be activated on the display screen and then a keyword will be inputted into a search box of a search engine. The conventional technology is time-consuming and troublesome. Whereas, in the present invention, the first server 41 of the TV program appended information display system 200 could automatically perform the internet searching operation according to the first information searching signal issued by the host 20 and the channel information. In addition, the searching results will be automatically sorted. By moving the mouse to click a desired displaying zone of the information frame 29, the detailed and complete contents of the TV program appended information will be shown in a hyperlink manner. As a consequence, the user could select the searching results of interest.

The above embodiments are illustrated by referring to digital TV signals. Nevertheless, the TV tuner card 24 of the host 20 could be designed to receive analog TV signals. After channel selections are implemented in the TV tuner card 24, the contents of the TV program are shown on the display screen 21. Unlike the digital TV signal, the channel information associated with the contents of the TV program is not included in the analog TV signal. In other words, the channel information and the analog TV signal fail to be simultaneously transmitted. Under this circumstance, the channel information is acquired by the host 20 in a specified approach.

In a case that the TV signal is in an analog format, the TV program appended information display system 200 of the present invention further includes a second server 42 to transmit the channel information to the host 20. Please refer to FIG. 2 again. The second server 42 communicates with the host 20 and the internet 30. When the application program is executed in the host 20, the host 20 issues a second information searching signal to the second server 42. In response to the second information searching signal, the second server 42 performs an internet searching operation to acquire the channel information, which is then transmitted to the host 20.

When the analog TV signal is received by the TV tuner card 24, a specified frequency is adjusted to receive the TV signal on a specified TV channel according to the channel selection. As such, a TV program corresponding to the TV signal will be shown on the display screen 21. In addition, the real-time video data of the TV signal are all received and reproduced in certain time intervals. As such, the host 21 will receive the TV signal from the TV channel according to the adjusted frequency. In addition, the timing of receiving the TV signal is determined according to the time status of the operating system of the host 20. According to the TV channel and the timing of receiving the TV signal, the host 20 issues the second information searching signal to the second server 42. In response to the second information searching signal, the second server 42 performs a searching operation on the internet 30 to acquire the channel information. For example, by the internet searching operation, the channel information is acquired by searching in TV channel frequencies and program schedules provided by TV stations.

Although the information is not as complete as the electronic programming guide that is used for the digital TV signal, the information associated with the TV channel frequencies and designated time is still helpful for the user to realize the current TV program. In other words, by the internet searching operation, the second sever 42 could realize the channel information such as the program name and the program category.

After the channel information has been successfully acquired by the second server 42, channel information will be transmitted to the host 20. The operation principles of the second server 42 are similar to those of the first server 41, and are not redundantly described herein. That is, the information received by the second server 42 is used as a keyword, and an internet searching operation is performed according to the predetermined software design. In some embodiments, a look-up table correlating the TV channel frequencies and the updated program schedule on a daily basis (e.g. the updated electronic programming guide) is periodically received by the second server 42. When the second information searching signal is received by the second server 42, the second sever 42 could immediately realize the channel information such as the program name and the program category according to the look-up table.

From the above discussion, even if the TV signal is in an analog format, the host 20 is able to acquire the channel information associated with the current TV program. After the channel information is acquired by the host 20, the host 20 issues the first information searching signal to the first server 41 according to the channel information. Via the first server 41, an internet searching function associated with the channel information is performed in order to obtain the desired TV program appended information. The process of acquiring the TV program appended information is similar to that for the digital TV signal, and is not redundantly described herein.

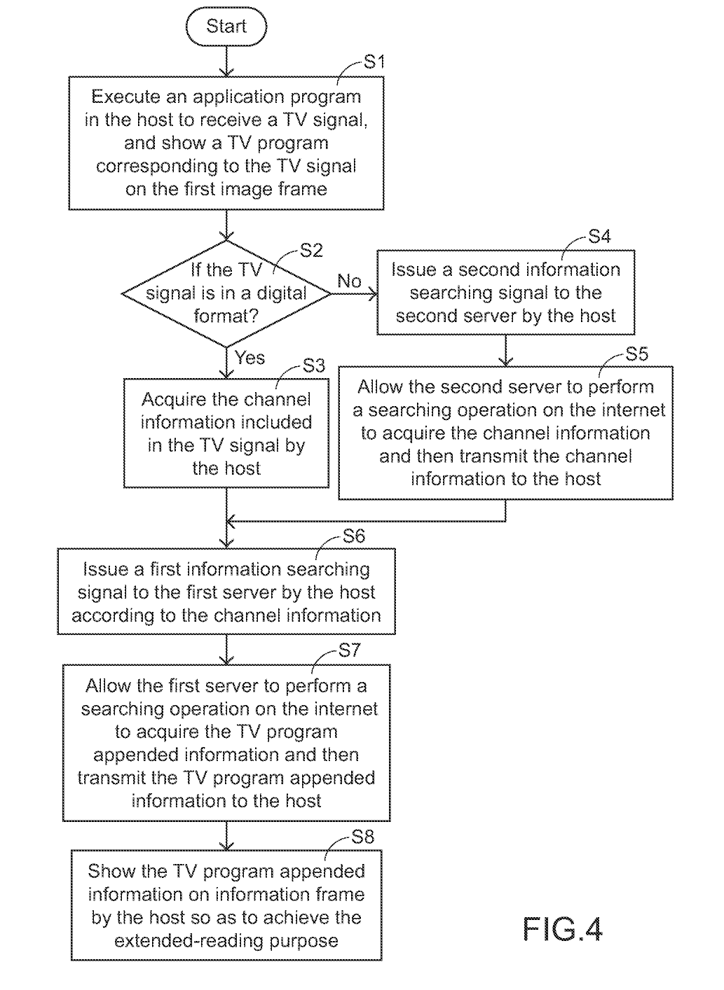

FIG. 4 is a flowchart illustrating a TV program appended information display system of the present invention. Hereinafter, the TV program appended information display system will be illustrated with reference to the flowchart of FIG. 4. First of all, an application program is executed in the host 20 to receive a TV signal, and a TV program corresponding to the TV signal is shown on the first image frame 28 (Step S1). Next, the format of the TV signal is analyzed. If the TV signal is in a digital format (Step S2), the channel information included in the TV signal is directly acquired by the host 20 (Step S3). If the TV signal is not in a digital format (e.g. in an analog format), the host 20 issues a second information searching signal to the second server 42 (Step S4). In response to the second information searching signal, the second server 42 performs a searching operation on the internet to acquire the channel information and then transmits the channel information to the host 20 (Step S5). After the channel information is acquired by the host 20, the host 20 issues a first information searching signal to the first server 41 according to the channel information (Step S6). In response to the first information searching signal, the first server 41 performs a searching operation on the internet to acquire the TV program appended information and then transmits the TV program appended information to the host 20 (Step S7). Afterwards, the TV program appended information is shown on the information frame 29 by the host 20 in order to achieve the extended-reading purpose while watching the TV program (Step S8).

In the above embodiments, the present invention illustrated by referring to a computer system including a host 20 and a display screen 21, wherein the host 20 has a built-in TV tuner card 24 for receiving TV signals and reproducing TV programs. The hardware components of the present invention are substantially identically to those used in the prior art. On the other hand, the functions of transmitting, displaying and processing associated signals are implemented according to the software or firmware design. By an application program included in the TV tuner card, the TV program appended information is automatically shown on the display screen without the need of manual operations. In other words, the concept of the present invention could be applied to a digital TV set including a host and a display screen and having a net-surfing function. By manipulating the remote controller or other control device of the digital TV set, the purpose of acquiring the TV program appended information is achieved.

Moreover, after the channel information is obtained, the tasks of automatically searching, sorting and transmitting the TV program appended information are implemented by the first server 41. In a case that the hardware components are able to support the application program, the application program could be designed to implement the tasks executable in the first server 41. In other words, the tasks of automatically searching, sorting and transmitting the TV program appended information are implemented by linking the host 20 to the internet 30, and thus the first server 41 (or the second server 42 for the analog TV signal) is exempted. When the channel information is obtained by the host 20 and the application program is executed in the host 20, a searching operation on the internet 30 could be performed to acquire the TV program appended information.

From the above description, the TV program appended information display system and display method of the present invention can facilitate the user to quickly obtain information associated with the current TV program. Since the TV program appended information is automatically acquired when the TV program is shown on the display screen, the TV program appended information display method of the present invention is very user-friendly. In addition, opening the video file or data corresponding to the TV program appended information will not become hindrance from viewing the TV program, but enhance applications and entertainments. In comparison with the convention technology of the YouTube video sharing website, the TV program appended information display method of the present invention can achieve the extended-reading purpose. In addition, the present invention can be used to reproduce the real-time TV programs from all TV channels of various TV stations.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A TV program appended information display system for use in an internet, the TV program appended information display system comprising:
a display screen; and
a host communicating with the display screen for executing an application program to receive a TV signal, showing a TV program corresponding to the TV signal on a first image frame of the display screen, and acquiring channel information associated with contents of the TV program,
wherein the host communicates with the internet to acquire TV program appended information through the internet according to the channel information, so that the TV program appended information is shown on the display screen by the host.

2. The TV program appended information display system according to claim 1 wherein the TV program appended information is acquired by executing the application program in the host and performing a searching operation in the internet according to the channel information.

3. The TV program appended information display system according to claim 1 further comprising a first server communicating with the host and the internet, wherein the host issues a first information searching signal to the first server according to the channel information, so that the first server performs a searching operation on the internet to generate the TV program appended information according to the channel information and then transmits the TV program appended information to the host.

4. The TV program appended information display system according to claim 1 wherein the channel information is included in the TV signal if the TV signal is in a digital format.

5. The TV program appended information display system according to claim 1 wherein the TV signal is in an analog format, and the TV program appended information display system further comprises a second server communicating with the host and the internet, wherein the host issues a second information searching signal to the second server, and the second server performs a searching operation on the internet to acquire the channel information in response to the second information searching signal and then transmits the channel information to the host.

6. The TV program appended information display system according to claim 1 wherein the channel information includes an electronic programming guide, or a program name, a program category, or a channel number of the TV program.

7. The TV program appended information display system according to claim 1 wherein the TV program appended information is shown on an information frame of the display screen.

8. The TV program appended information display system according to claim 7 wherein the information frame is arranged beside the first image frame, or the information frame and the first image frame are shown on the display screen in a picture-in-picture mode.

9. The TV program appended information display system according to claim 1 wherein the TV program appended information includes a text remark about the TV program, a rating of the TV program, related advertisement or recommended information.

10. The TV program appended information display system according to claim 1 wherein a second image frame is created when the TV program appended information is clicked, and the whole contents of the TV program appended information are shown on the second image frame.

11. The TV program appended information display system according to claim 10 wherein the TV program appended information shown on the second image frame is in a video format, a sound format, a picture format or a text format.

12. A TV program appended information display method for use with a computer system including a host and a display screen, the host communicating with an internet, the TV program appended information display method comprising steps of:
executing an application program in the host to receive a TV signal, and showing a TV program corresponding to the TV signal on a first image frame of the display screen;
acquiring channel information associated with the contents of the TV program by the host, and acquiring TV program appended information through the internet according to the channel information; and
showing the TV program appended information on the display screen by the host.

13. The TV program appended information display method according to claim 12 wherein the TV program appended information is acquired by executing the application program in the host and performing a searching operation on the internet according to the channel information.

14. The TV program appended information display method according to claim 12 wherein a first server communicates with the host and the internet, and the TV program appended information display method further comprises steps of:
issuing a first information searching signal to the first server by the host;
allowing the first server to perform a searching operation on the internet to generate the TV program appended information according to the channel information in response to the first information searching signal; and
allowing the first server to transmit the TV program appended information to the host.

15. The TV program appended information display method according to claim 12 wherein the channel information is included in the TV signal if the TV signal is in a digital format.

16. The TV program appended information display method according to claim 12 wherein the TV signal is in an analog format, a second server communicates with the host and the internet, and the TV program appended information display method further comprises steps of:
issuing a second information searching signal to the second server by the host;
allowing the second server to perform a searching operation on the internet to acquire the channel information in response to the second information searching signal; and
allowing the second server to transmit the channel information to the host.

17. The TV program appended information display method according to claim 12 wherein the TV program appended information includes a text remark about the TV program, a rating of the TV program, related advertisement or recommended information.

18. The TV program appended information display method according to claim 12 further comprising steps of:
creating a second image frame on the display screen by clicking the TV program appended information; and
showing the whole contents of the TV program appended information on the second image frame.

19. The TV program appended information display method according to claim 18 wherein the TV program appended information shown on the second image frame is in a video format, a sound format, a picture format or a text format.
